(19) United States
(12) Patent Application Publication
(10) Pub. No.: US 2008/0143120 A1
(43) Pub. Date: Jun. 19, 2008

(54) Device for locking door of a tray in a vehicle

(76) Inventor: Jong Yoon Lee, Seoul (KR)

Correspondence Address: MORGAN, LEWIS & BOCKIUS LLP (SF), One Market, Spear Street Tower, Suite 2800, San Francisco, CA, 94105, US

(21) Appl. No.: 11/646,118

(22) Filed: Dec. 26, 2006

(30) Foreign Application Priority Data
Oct. 10, 2006 (KR) 10-2006-0098532

(51) Int. Cl. E05C 21/00

(52) U.S. Cl. 292/1

(57) ABSTRACT

The present invention relates to a device for locking a door of a tray for a vehicle which can prevent the door of the tray from being unexpectedly opened by a strong impact. A device for locking a door of a tray for a vehicle includes a locking device connected integrally to the door of the tray via a link device and can positioned at the receiving hole which is formed at the rear of the main body housing.

### CROSS-REFERENCE TO RELATED APPLICATION

This application claims priority to Korean Patent Application No. 10-2006-0098532 filed in the Korean Intellectual Property Office on Oct. 10, 2006, the disclosure of which is incorporated herein by reference.

### BACKGROUND OF THE INVENTION

(a) Field of the Invention

The present invention relates to a device for locking a door of a tray in a vehicle. In particular, the device prevents the door of the tray from being unexpectedly opened by a strong impact, thereby preventing items contained in the tray from being unnecessarily thrown out and injuring an occupant.

(b) Description of the Related Art

Generally, a tray is provided in the passenger compartment of a vehicle for convenience. An example of a tray includes an ashtray for cigarette butts and cigarette ash and a cup holder for holding a cup. In addition, a CD tray for storing CDs is also provided in a vehicle.

The present invention provides a device for locking a door of a tray of a vehicle which prevents a door of a tray from being unexpectedly opened by a strong impact and prevents dangerous things contained in the tray from being thrown out so as to prevent an injury on an occupant.

### SUMMARY OF THE INVENTION

In one embodiment of the present invention, a device for locking a door of a tray for a vehicle includes a locking device connected integrally to the door of the tray via a link device and is disposed at a receiving hole which is formed in the rear of the main body housing.

In an exemplary embodiment, the locking device may have a clip shape including: an intermediate member formed integrally with a fixing strip; and elastic members which enters into the receiving hole while an outer portion of the elastic members thereof are interfered in an elastic coupling with the receiving hole and having elasticity which allows open sides thereof to be interfered with a main body housing in being drawn out from the receiving hole and thereby being coupled, and being slanted in a moving direction at an upside and a downside of the intermediate member.

The link device may include: a fixing strip at a lower end in which a plurality of teeth are formed; a link member of one end of which is connected through the hinge to the fixing strip and the second end of which is connected through the hinge to the door so as to open and close the door according to an operation of the fixing strip; and a rotating gear engaged with the teeth formed at a lower end of the fixing strip so as to guide the fixing strip.

### BRIEF DESCRIPTION OF THE DRAWINGS

FIG. 1 is a sectional view of a tray of a vehicle according to an exemplary embodiment of the present invention.

FIG. 2 is a drawing showing a device for locking a door of a tray for a vehicle according to an exemplary embodiment of the present invention.

FIG. 3 is a drawing showing a state of a device for locking a door of a tray for a vehicle according to an exemplary embodiment of the present invention after its operation.

FIG. 4 is a drawing showing a general instrument panel for a vehicle

FIG. 5 is a cross sectional view of a conventional device for locking a door of a tray for a vehicle.

### DESCRIPTION OF REFERENCE NUMERALS INDICATING PRIMARY ELEMENTS IN THE DRAWINGS

10: tray 11: fixing strip

11a: tooth 12: rotating gear

13: latch 20: door

21: link member 30: locking device

31: intermediate member 32, 33: elastic member

40: main body housing 41: receiving hole

50: link device

### DETAILED DESCRIPTION OF THE INVENTION

An exemplary embodiment of the present invention will hereinafter be described in detail with reference to the accompanying drawings.

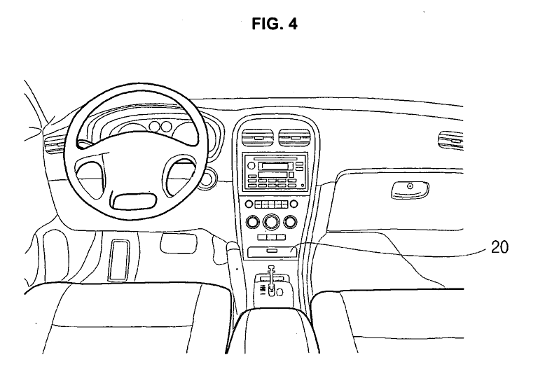

As shown in FIG. 4, the tray is generally provided at the center of the instrument panel, and a cover is rotatably connected to a front portion thereof so as to open and close an inner space of the tray.

In other words, the door 20 closes the inner space of the tray while the tray is not being used. The door 20 opens the inner space of the tray while the tray is being used so that things contained in the tray can be easily taken out. Therefore, the tray is convenient to occupants in a vehicle.

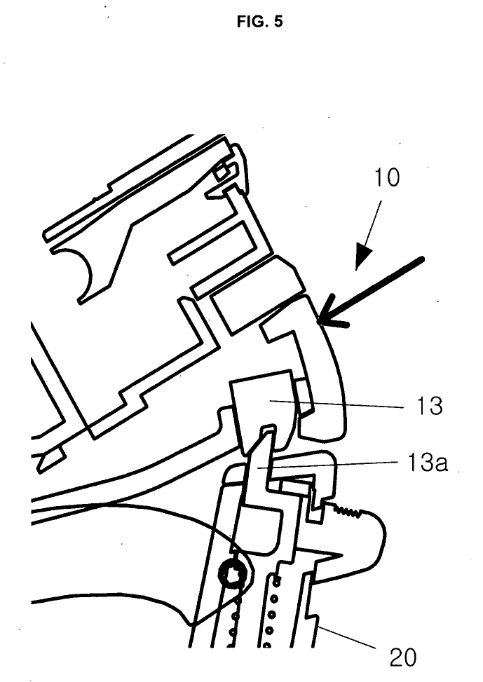

As shown in FIG. 5, in a conventional method for fixing a door of a tray, a locking device (e.g. a latch 13) which regulates movements of a door inside the tray is used.

Furthermore, the latch 13 is provided inside a tray 10, and a fixing pin 13a which is fitted into the latch 13 or is separated from the latch 13 is provided to the door 20. The door 20 is opened or closed by the fixing pin 13a and the latch 13.

Although the door 20 of the conventional tray for a vehicle is effectively controlled to prevent things contained therein from being thrown out, there is a problem in that when the fixing pin 13a is separated from the latch 13 by an unexpected impact while a vehicle runs, the door 20 of the tray 10 may be opened. Therefore, when the door 20 of the tray 10 is opened, things in the tray may be unexpectedly thrown out so as to injure an occupant.

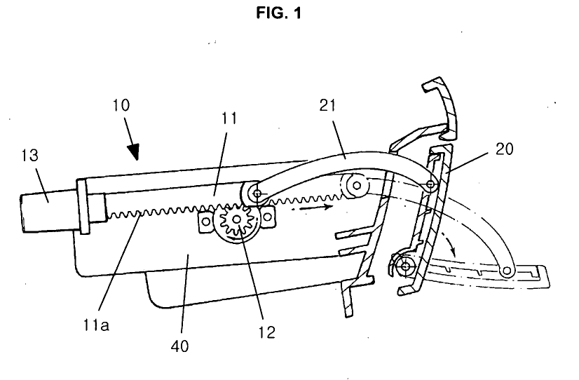

As shown in FIG. 1, an exemplary embodiment of the present invention prevents a door 20 which is provided in front of a tray 10 from being unnecessarily opened by unexpected impact while a vehicle drives.

The door 20 is rotatably connected to a front portion of the tray 10 so as to open and close an inner space thereof. A latch 13, which is a push-open type locking device, is provided on an inner surface of the tray 10 so as to regulate the rotation of the door 20.

In addition, a fixing strip 11, which is a rack gear type and is disposed at a lower end of which a plurality of teeth 11a are formed, is coupled to the, latch 13, so as to be fitted or to be separated according to the operation of the door 20. Moreover, one end of a link member 21 is connected through a hinge to the door 20, and the second end thereof is connected through a hinge to an end of the fixing strip 11.

In addition, a rotating gear 12 is a type of a pinion gear and is engaged with the teeth 11a of the fixing strip 11 so as to guide the fixing strip 11 which have been separated from the latch 13. The rotating gear 12 is provided at a side of the tray 10 under the fixing strip 11.

Accordingly, the fixing strip 11 is fitted into the latch 13 in a normal state such that an inner space of the tray 10 is closed by the door 20. When the door 20 is pushed, the fixing strip 11 is separated from the latch 13 so that the door 20 is opened by the link member 21.

At this time, the fixing strip 11 which has been separated from the latch 13 is guided by the rotating gear 12 which is provided at a side of the tray 10, so that the fixing strip 11 does not deviate from a route in an engaged gear type. In other words, during the push operation of the door 20, the fixing strip 11 which is separated from the latch 13 is moved forward while being guided by the rotating gear 12. The link member 21 is moved forward by the forward movement of the fixing strip 11 and is rotated downward, thereby opening the door 20.

When the door 20 is rotated upward by an occupant in order to close the door 20, the link member 21 and the fixing strip 11 are moved backward respectively. Consequently, the fixing strip 11 is fitted into the latch 13, so as to close to an inner space of the tray 10.

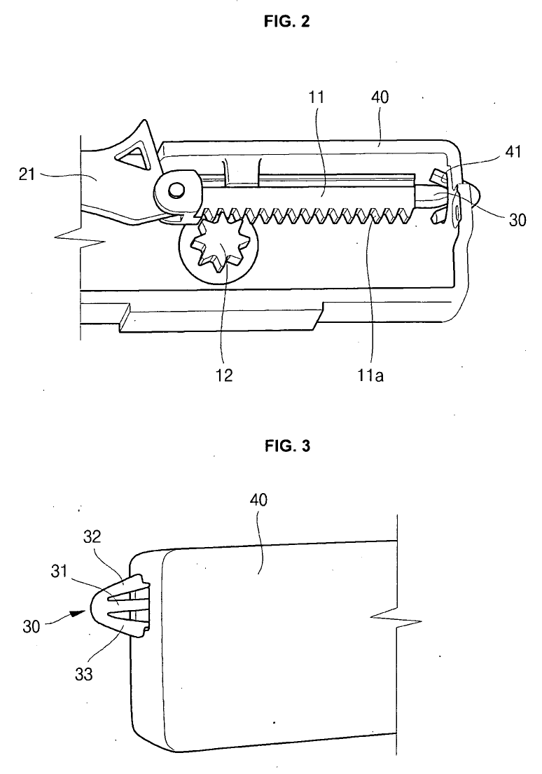

Meanwhile, as shown in FIG. 2, a locking device 30 for preventing the door 20 of the tray 10 from being unnecessarily opened by unexpected impact is provided. The locking device 30 is formed in a shape of a clip which is formed integrally with a rear end of second fixing strip 11 which is positioned at an opposite side of the first fixing strip 11 to which the latch 13 is formed. A receiving hole 41 is formed at the main body housing 40 at a rear side so that the locking device 30 can be pushed to further get into beyond a normal operation range by the impact.

At this time, the clip shape of the locking device 30 is comprised of: an intermediate member 31 which is formed integrally with the fixing strip 11; and elastic members 32 and 33 which have elasticity and are slanted along a moving direction of the intermediate member 31. Thus, when the locking device 30 is elastically coupled to the receiving hole 41, the locking device 30 enters into the receiving hole 41 while an outer portion thereof is interfered with the receiving hole 41. When the locking device 30 is drawn out from the receiving hole 41 so as to be coupled, the open sides of the elastic members 32 and 33 interfere with the main body housing 40 so that it is not separated after the coupling.

Accordingly, if there is an impact such as a vehicle crash, as shown in FIG. 3, the fixing strip 11 moves backward by the impact. The locking device 30 is formed integrally with an end of the fixing strip 11 and gets into the receiving hole 41 which is formed at the main body housing 40 so as to be coupled. Therefore, the fixing strip 11 is firmly restrained.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A device for locking a door of a tray for a vehicle comprising: a locking device connected integrally to the door of the tray via a link device and disposed at a receiving hole formed in the rear of a main body housing.

2. The device of claim 1, wherein the locking device has a clip shape comprising:
an intermediate member formed integrally with a fixing strip; and
elastic members which enter into the receiving hole while an outer portion thereof is interfered in an elastic coupling with the receiving hole and having elasticity which allows open sides thereof to be interfered with a main body housing in being drawn out from the receiving hole and thereby being coupled, and being slanted in a moving direction at an upside and a downside of the intermediate member.

3. The device of claim 1, wherein the link device comprises:
a fixing strip at a lower end of which a plurality of teeth are formed;
a link member in which one end of which is connected through the hinge to the fixing strip and the second end of which is connected through the hinge 2 to the door so as to open and close the door according to an operation of the fixing strip; and
a rotating gear engaged with the teeth formed at a lower end of the fixing strip so as to guide the fixing strip.
